(19) United States
(12) Patent Application Publication
(10) Pub. No.: US 2026/0172087 A1
(43) Pub. Date: Jun. 18, 2026

(54) METHOD OF BEAMFORMING FOR SENSING AND TRACKING A TARGET IN 5G NETWORKS

(71) Applicant: TIAMI NETWORKS INC., Elk Grove, CA (US)

(72) Inventors: Amitav Mukherjee, Elk Grove, CA (US); SAEEDE ENAYATI, Elk Grove, CA (US)

(73) Assignee: TIAMI NETWORKS INC., Elk Grove, CA (US)

(21) Appl. No.: 19/418,894

(22) Filed: Dec. 12, 2025

Related U.S. Application Data
(60) Provisional application No. 63/730,986, filed on Dec. 12, 2024.

(51) Int. Cl. H04B 7/06; H04B 17/309; H04L 5/00; H04W 4/38

(52) U.S. Cl. CPC H04B 7/0617; H04B 7/0626; H04B 17/346; H04L 5/0051; H04W 4/38

(57) ABSTRACT

According to an aspect of the present disclosure, a method of beamforming for sensing and tracking a target in a 5G (fifth generation) cellular network is performed in a base station in the 5G cellular network. The method comprises choosing a user equipment (UE) that is closest to the target; obtaining an orthogonal frequency division multiplexing (OFDM) symbol of a demodulation reference signal (DMRS) sent from the UE; estimating a channel state information (CSI) based on the OFDM symbol; and creating a beamforming vector for a receiver antenna of the base station.

### PRIORITY CLAIM

The instant patent application is related to and claims priority from the U.S. Provisional Application No. 63/730,986, Filed on: 12 Dec. 2024, entitled, “UL DM-RS BEAMFORMING FOR SENSING”, which is incorporated in its entirety herewith.

### BACKGROUND

### Technical Field

The disclosed embodiment is in the technical field of wireless communications, and more specifically to a method of beamforming for sensing and tracking a target in 5G (“fifth generation”) cellular networks.

### Description of the Related Art

Traditional target tracking methods often involve transmitting dedicated sensing signals, which can increase intra-cell and inter-cell interference.

Current Multi-User Multiple Input Multiple Output (MU-MIMO) systems struggle with integrating beamforming on uplink signals to ensure precise target tracking, while maintaining communication quality and minimizing interference.

Another challenge is requiring the beamforming configuration to efficiently support both communication and target tracking.

Therefore, there is an urgent need to develop a method to manage (uplink) beamforming for sensing in MU-MIMO cellular communication systems without introducing additional interference.

### SUMMARY

The following presents a simplified summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

According to an aspect of the present disclosure, a method of beamforming for sensing and tracking a target in a 5G (fifth generation) cellular network is performed in a base station in the 5G cellular network. The method comprises choosing a user equipment (UE) that is closest to the target; obtaining an orthogonal frequency division multiplexing (OFDM) symbol of a demodulation reference signal (DMRS) sent from the UE; estimating a channel state information (CSI) based on the OFDM symbol; and creating a beamforming vector for a receiver antenna of the base station.

According to another aspect of the present disclosure, the base station creates the beamforming vector that maximizes the Signal-to-Interference-plus Noise Ratio (SINR).

According to one more aspect of the present disclosure, the OFDM symbol is a first OFDM symbol in the DMRS, with the tracking of the target occurring through a second OFDM symbol in the DRMS.

According to a further aspect of the present disclosure, the base station tracks the target without adding further interference by making use of already transmitted uplink DMRS (UL-DMRS), while the CSI also facilitates beamforming for a data channel with the UE.

According to yet another aspect of the present disclosure, the DMRS is one of a type-1 that supports between 4 to 8 antenna ports and a type-2 that supports between 6 to 12 antenna ports.

According to an aspect of the present disclosure, the target is one of a vehicle, drone, and human, such that the base station is used for vehicle tracking, drone tracking, and human tracking.

Thus, aspects of the present disclosure effectively implement a method of beamforming based on uplink demodulation reference signals (UL DM-RS) for passive sensing, ensuring accurate tracking while minimizing complexity. The method involves, Integrated Sensing and Communication (ISAC) base station, User Equipment (UE), target, Demodulation Reference Signal (DMRS) and antenna ports.

Several aspects of the disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### BRIEF DESCRIPTION OF THE DRAWINGS

Example embodiments of the disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which beamforming for sensing and tracking a target in 5G cellular networks is facilitated according to the aspects of the disclosed embodiment.

FIG. 3 illustrates an overview of Type 1 demodulation reference signals that are multiplexed across multiple antennas in a MIMO (Multiple Input, Multiple Output) 5G system, according to the aspects of the present embodiment.

FIG. 4 illustrates an overview of Type 2 demodulation reference signals that are multiplexed across multiple antennas in a MIMO (Multiple Input, Multiple Output) 5G system, according to the aspects of the present embodiment.

FIG. 5 is a block diagram illustrating the details of a digital processing system in which various aspects of the present disclosure are operative by execution of appropriate execution modules, according to the aspects of the disclosed embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

As used herein, the singular forms “a”, “an”, and “the” include both singular and plural referents unless the context clearly dictates otherwise. By way of example, “a dosage” refers to one or more than one dosage. The terms “comprising”, “comprises” and “comprised of” as used herein are synonymous with “including”, “includes” or “containing”, “contains”, and are inclusive or open-ended and do not exclude additional, non-recited members, elements, or method steps.

All documents cited in the present specification are hereby incorporated by reference in their totality. In particular, the teachings of all documents herein specifically referred to are incorporated by reference.

Example embodiments of the present disclosure are described with reference to the accompanying figures.

### 1. Definitions

The term “MU-MIMO (multi-user, multiple input, multiple output)” refers to a wireless technology that allows a single access point to send data to multiple devices at once.

The term “ISAC (Integrated Sensing and Communication)” refers to the technologies that combine sensing and communication systems to utilize wireless resources efficiently, realize wide area environment sensing, and even to pursue mutual benefits.

The term “UL DMRS” refers to a signal that helps a base station to understand the quality of signal coming from a device (such as a user equipment). The device sends a test signal along with actual data, so that the base station can figure out how to receive and decode the data correctly.

The term “Intracell” refers to within the cell. Intracellular signaling occurs within the boundaries of a cell.

The term “Inter-cell” refers to between the cells. Intercellular signaling occurs between cells in the extracellular matrix.

The term “Beamforming” refers to a technique used in wireless communication systems to focus energy in a specific direction.

The term “Orthogonal Frequency-Division Multiplexing (OFDM)” refers to a modulation technique that is used to increase wireless capacity and efficiency.

The term “CDM (Code Division Multiplexing)” refers to a technique that allows multiple users to share a single frequency spectrum by assigning a unique digital code to each user.

The term “CSI (Channel State Information)” refers to a set of known properties of a wireless communication link that describes how a signal moves from the transmitter to the receiver.

The term “OCC (Orthogonal Cover Code)” refers to a coding technique used in wireless communication system to mitigate interference and improve system performance.

The term “Passive Sensing” refers to a variety of technologies that use natural energy sources to detect or measure energy emitted or reflected from an object.

### 2. Example Environment

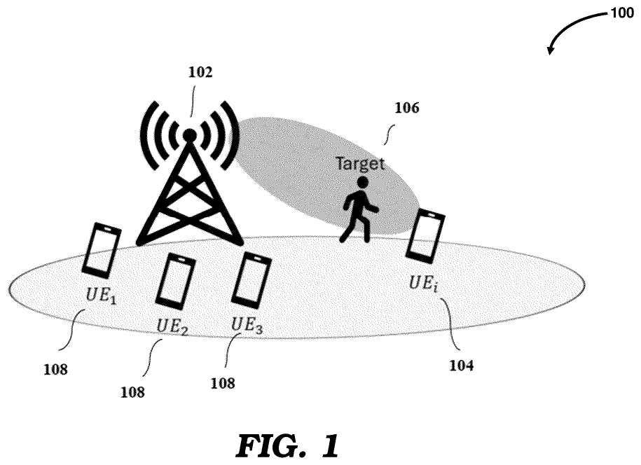

FIG. 1 is a block diagram illustrating an example environment (computing system) in which several aspects of the present disclosure can be implemented. 100 illustrates a wireless communication system (5G network) for sensing and tracking a target 106.

Base station 102 is an ISAC base station (102) capable of sensing as well as communication. The ISAC frequency selection logic at base station 102 determines which frequency to use for specific applications based on factors like transmit powers, available bandwidth, congestion levels, and propagation losses.

User Equipment (UE) 104 and 108 refer to devices such as smartphones, tablets, and IoT devices that connect to 5G cellular networks (via base station 102) to access services. As such, UE 104 and 108 may send uplink demodulation reference signals (UL-DMRS) to help base station 102 to understand the quality of the signals coming from the corresponding user equipment.

Aspects of the present disclosure are directed to beamforming for sensing and tracking a target (106) in such an environment (100) as described in detail below.

### 3. General Flow

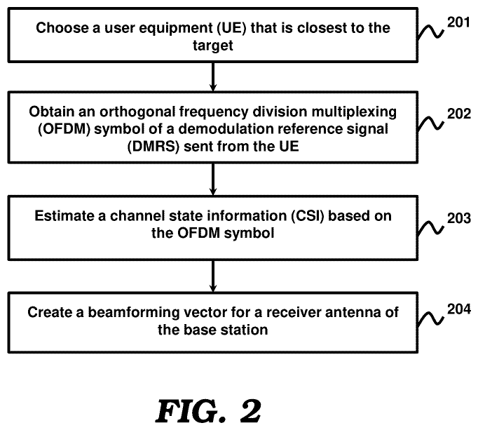

FIG. 2 is a flow chart illustrating the manner in which beamforming for sensing and tracking a target in 5G cellular networks is facilitated according to the aspects of the disclosed embodiment. The flowchart is described with respect to FIG. 1, in particular base station 102 merely for illustration. However, various features can be implemented in other systems and/or other environments also without departing from the scope of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention.

In step 201, base station 102 chooses a user equipment (UE) that is closest to a target (106) sought to be sensed/detected. In the environment 100 of FIG. 1, base station 102 chooses UEᵢ 104 as the user equipment is closest to the target.

In step 202, base station 102 obtains an orthogonal frequency division multiplexing (OFDM) symbol of a (uplink) demodulation reference signal (DMRS) sent from the closes UE (104). According to an aspect, the DMRS is one of a type-1 that supports between 4 to 8 antenna ports and a type-2 that supports between 6 to 12 antenna ports.

In step 203, base station 102 estimate a channel state information (CSI) based on the OFDM symbol. The estimation may be performed in a known way. According to an aspect, the OFDM symbol is a first OFDM symbol in the DMRS, with the tracking of the target occurring through a second OFDM symbol in the DRMS.

In step 204, base station 102 creates a beamforming vector for a receiver antenna of the base station 102. According to an aspect, base station 102 creates the beamforming vector that maximizes the Signal-to-Interference-plus Noise Ratio (SINR). The beamformed vector may thereafter be used to track the target (106)

According to another aspect, base station 102 tracks the target (106) without adding further interference by making use of already transmitted uplink DMRS (UL-DMRS), while the CSI also facilitates beamforming for a data channel with the UE.

Thus, base station 102 uses the uplink DM-RS signals from the closest UE (104) to passively track a target (106). This present disclosure integrates sensing capabilities into the base station (102) without requiring exclusively allocated resources. According to an aspect, the target (106) is one of a vehicle, drone, and human, such that the base station (102) is used for vehicle tracking, drone tracking, and human tracking. The manner in which several aspects of the present disclosure are provided according to the operation of FIG. 2 is described in detail below.

### 4. Sample Implementation

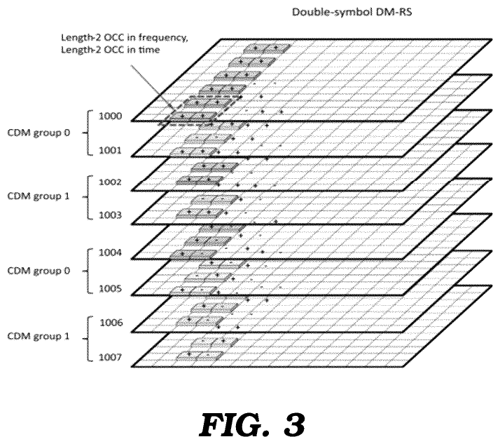

FIG. 3 illustrates an overview of Type 1 demodulation reference signals that are multiplexed across multiple antennas in a MIMO (Multiple Input, Multiple Output) 5G system, according to the aspects of the present embodiment. The type 1 DM-RS with 8 antenna ports used in a MIMO (Multiple Input, Multiple Output) system is shown there. The figure illustrates the multiplexing of demodulation reference signals across these antenna ports, facilitating efficient signal transmission and reception in a multi-user setup

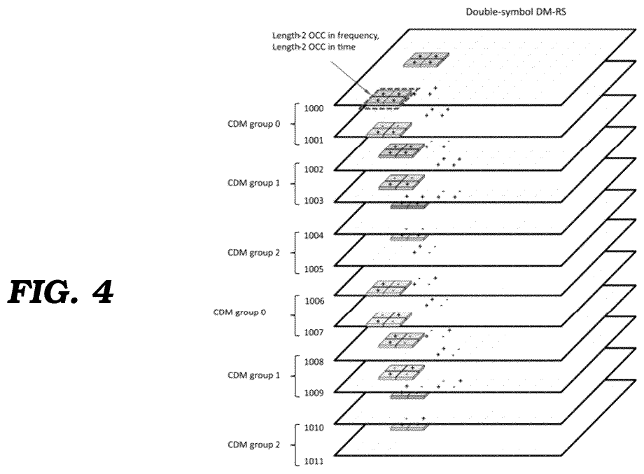

FIG. 4 illustrates an overview of Type 2 demodulation reference signals that are multiplexed across multiple antennas in a MIMO (Multiple Input, Multiple Output) 5G system, according to the aspects of the present embodiment. The type 2 DM-RS with 12 antenna ports is shown there. The figure illustrates the extended capacity for antenna support compared to Type 1, demonstrating how additional ports improve signal handling and reliability for advanced MIMO communication systems. Notably, both types are capable of supporting either 1 or 2 OFDM symbols.

When a user equipment (hereinafter UE) is identified as the closest (104) to the target (106) using positioning data, the identified UE should be allocated two OFDM symbol DM-RS. This approach allows base station 102 to first receive the initial OFDM symbol of the DM-RS. Subsequently, base station 102 (hereinafter (BS) can estimate the channel state information (CSI) from the first OFDM symbol and utilize that CSI estimation to perform receive beamforming for the second DM-RS symbol. The tracking of the target occurs through the second OFDM symbol. Concurrently, the UE's CSI is also estimated to facilitate beamforming for the UE's data channel.

An example implementation of this method is given below:

Assume that the UL DM-RS signal is denoted by s(n) and the channel from the UE to the BS as h∈C^{M×1}. Also, the beamforming vector at the BS is denoted by

$${}_{w ∈} {C}^{M \times 1} , w = [ {w}_{1} , {w}_{2} , … , {w}_{M} ] \hat{H}$$

The received signal at the BS is written as

$$y [ n ] = {w}^{H} h s ( n ) + {\sum }_{k = 1}^{K} {w}^{H} {h}_{k} {s}_{k} ( n ) + {w}^{H} n , \qquad ( 1 )$$

Where,

$${\sum }_{k = 1}^{K} {w}^{H} {h}_{k} {s}_{k} ( n )$$

is the interference term from the nearby K cells and n∈CN(0,σ²Iₙ) is the noise vector at the BS.

The SINR can be obtained as

$$SINR = \frac{{\vert {w}^{H} h \vert}^{2} E [ {\vert s ( n ) \vert}^{2} ]}{{\sum }_{k = 1}^{K} {\vert {w}^{H} {h}_{k} \vert}^{2} E [ {\vert {s}_{k} ( n ) \vert}^{2} ] + {σ}^{2}} \qquad ( 2 )$$

In order to maximize the tracking accuracy, the BS needs to maximize the received signal. The BS needs to solve the following optimization problem to obtain the beamforming vector:

$${max}_{w} SINR , \qquad ( 3 )$$

$$Subject to {‖ w ‖}^{2} = 1$$

This is the receive beamformer at the BS to maximize the SINR received from the target.

Thus, the 3 major phases of the method are: (1) Choosing the closest UE to the target; (2) Receiving the first OFDM symbol of the DM-RS from the user and estimate the CSI to the UE; and (3) Designing the beamform vector for the receiver antenna at the BS.

### 5. Uses, Applications and Benefits of the Disclosure

This disclosure allows for the integration of sensing capabilities into the BS without the need for dedicated resources. The proposed system makes beamforming possible for the sensing signal, which improves tracking performance.

This method is used in various sectors for their safety and security measures. Mostly used in vehicle tracking, drone tracking, and human tracking.

Best mode to practice the present disclosure is which simplifies the method of its incorporation in Integrated Sensing and Communications, which is expected to be a potential candidate for the Sixth Generation (6G) of wireless communications.

At this point, telecom operators will be commercially using devices that combine the instant technology into their products and allow the users to sense and handle the tasks which is beneficial as there isn't any need for extra hardware for this scenario for only sensing purposes.

This innovation is concerned with incorporating beamforming capability for the UL DM-RS in the BS (base station).

It should be appreciated that the above noted features can be implemented in various embodiments as a desired combination of one or more of hardware, execution modules and firmware. The description is continued with respect to one embodiment in which various features are operative when execution modules are executed.

### 6. Hardware

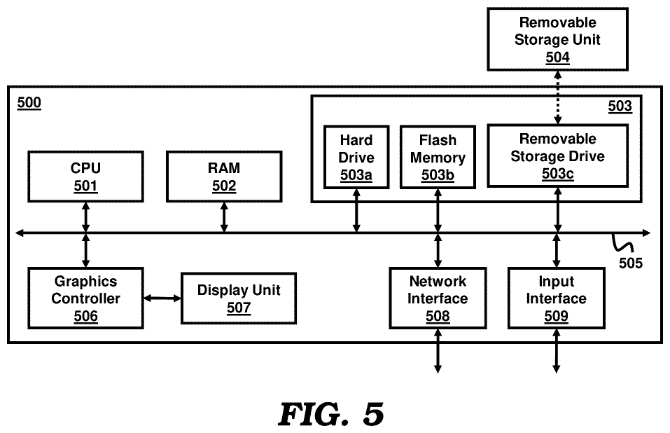

FIG. 5 is a block diagram illustrating the details of digital processing system (500) in which various aspects of the present invention are operative by execution of appropriate execution modules. Digital processing system 500 may correspond to any of base station (such as 102) or user equipment (such as 108) in the 5G cellular network.

Digital processing system 500 may contain one or more processors (such as a central processing unit (CPU) 501), random access memory (RAM) 502, secondary memory 503, graphics controller 506, display unit 507, network interface 508, and input interface 509. All the components except display unit 507 may communicate with each other over communication path 505 which may contain several buses as is well known in the relevant arts. The components of FIG. 5 are described below in further detail.

CPU 501 may execute instructions stored in RAM 502 to provide several features of the present invention. CPU 501 may contain multiple processing units, with each processing unit potentially being designed for a specific task. Alternatively, CPU 501 may contain only a single general-purpose processing unit. RAM 502 may receive instructions from secondary memory 503 using communication path 505.

Graphics controller 506 generates display signals (e.g., in RGB format) to display unit 507 based on data/instructions received from CPU 501. Display unit 507 contains a display screen to display the images defined by the display signals. Input interface 509 may correspond to a keyboard and a pointing device (e.g., touch-pad, mouse), which enable the various inputs to be provided.

Network interface 508 provides connectivity to a network (e.g., using Internet Protocol), and may be used to communicate with other connected systems. Network interface 508 may provide such connectivity over a wire (in the case of TCP/IP based communication) or wirelessly (in the case of WIFI, Bluetooth based communication).

Secondary memory 503 may contain hard drive 503a, flash memory 503b, and removable storage drive 503c. Secondary memory 503 may store the data (e.g., OFDM symbols) and software instructions (e.g., for implementing the steps of FIG. 2), which enable digital processing system 500 to provide several features in accordance with the present invention.

Some or all of the data and instructions may be provided on removable storage unit 504, and the data and instructions may be read and provided by removable storage drive 503c to CPU 501. Floppy drive, magnetic tape drive, CD-ROM drive, DVD Drive, Flash memory, removable memory chip (PCMCIA Card, EPROM) are examples of such removable storage drive 503c.

Removable storage unit 504 may be implemented using storage format compatible with removable storage drive 503c such that removable storage drive 503c can read the data and instructions. Thus, removable storage unit 504 includes a computer readable storage medium having stored therein computer software (in the form of execution modules) and/or data.

However, the computer (or machine, in general) readable storage medium can be in other forms (e.g., non-removable, random access, etc.). These “computer program products” are means for providing execution modules to digital processing system 500. CPU 501 may retrieve the software instructions (forming the execution modules) and execute the instructions to provide various features of the present invention described above.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the invention have been shown and described in detail to illustrate the inventive principles, it will be understood that the invention may be embodied otherwise without departing from such principles.

The figures and/or screen shots shown highlighting the functionality and advantages of the present invention are presented for example purposes only. The present invention is sufficiently flexible and configurable, such that it may be utilized in ways other than that shown in the figures.

The examples and embodiments described herein are for illustrative purposes only and that various modifications or changes in light thereof will be suggested to persons skilled in the art and are to be included within the spirit and purview of this application and scope of the appended claims.

What is claimed is:

1. A method of beamforming for sensing and tracking a target in a 5G (fifth generation) cellular network, the method being performed in a base station in the 5G cellular network, the method comprising:
choosing a user equipment (UE) that is closest to the target;
obtaining an orthogonal frequency division multiplexing (OFDM) symbol of a demodulation reference signal (DMRS) sent from the UE;
estimating a channel state information (CSI) based on the OFDM symbol; and
creating a beamforming vector for a receiver antenna of the base station.

2. The method of claim 1, wherein the base station creates the beamforming vector that maximizes the Signal-to-Interference-plus Noise Ratio (SINR).

3. The method of claim 1, wherein the OFDM symbol is a first OFDM symbol in the DMRS, wherein tracking of the target occurs through a second OFDM symbol in the DRMS.

4. The method of claim 1, wherein the base station tracks the target without adding further interference by making use of already transmitted uplink DMRS (UL-DMRS),
wherein the CSI also facilitates beamforming for a data channel with the UE.

5. The method of claim 1, wherein the DMRS is one of a type-1 that supports between 4 to 8 antenna ports and a type-2 that supports between 6 to 12 antenna ports.

6. The method of claim 1, wherein the target is one of a vehicle, drone, and human, wherein the base station is used for vehicle tracking, drone tracking, and human tracking.

7. A base station in a 5G (fifth generation) cellular network to perform beamforming for sensing and tracking a target in the 5G cellular network, the base station configured to perform the actions of:
choosing a user equipment (UE) that is closest to the target;
obtaining an orthogonal frequency division multiplexing (OFDM) symbol of a demodulation reference signal (DMRS) sent from the UE;
estimating a channel state information (CSI) based on the OFDM symbol; and
creating a beamforming vector for a receiver antenna of the base station.

8. The base station of claim 7, wherein the base station creates the beamforming vector that maximizes the Signal-to-Interference-plus Noise Ratio (SINR).

9. The base station of claim 7, wherein the OFDM symbol is a first OFDM symbol in the DMRS, wherein tracking of the target occurs through a second OFDM symbol in the DRMS.

10. The base station of claim 7, wherein the base station tracks the target without adding further interference by making use of already transmitted uplink DMRS (UL-DMRS),
wherein the CSI also facilitates beamforming for a data channel with the UE.

11. The base station of claim 7, wherein the DMRS is one of a type-1 that supports between 4 to 8 antenna ports and a type-2 that supports between 6 to 12 antenna ports.

12. The base station of claim 7, wherein the target is one of a vehicle, drone, and human, wherein the base station is used for vehicle tracking, drone tracking, and human tracking.

13. A non-transitory machine-readable medium storing one or more sequences of instructions to perform beamforming for sensing and tracking a target in a 5G (fifth generation) cellular network, wherein execution of said one or more instructions by one or more processors contained in a base station in the 5G cellular network causes the base station to perform the actions of:
choosing a user equipment (UE) that is closest to the target;
obtaining an orthogonal frequency division multiplexing (OFDM) symbol of a demodulation reference signal (DMRS) sent from the UE;
estimating a channel state information (CSI) based on the OFDM symbol; and
creating a beamforming vector for a receiver antenna of the base station.

14. The non-transitory machine-readable medium of claim 13, wherein the base station creates the beamforming vector that maximizes the Signal-to-Interference-plus Noise Ratio (SINR).

15. The non-transitory machine-readable medium of claim 13, wherein the OFDM symbol is a first OFDM symbol in the DMRS, wherein tracking of the target occurs through a second OFDM symbol in the DRMS.

16. The non-transitory machine-readable medium of claim 13, wherein the base station tracks the target without adding further interference by making use of already transmitted uplink DMRS (UL-DMRS),
wherein the CSI also facilitates beamforming for a data channel with the UE.

17. The non-transitory machine-readable medium of claim 13, wherein the DMRS is one of a type-1 that supports between 4 to 8 antenna ports and a type-2 that supports between 6 to 12 antenna ports.

18. The non-transitory machine-readable medium of claim 13, wherein the target is one of a vehicle, drone, and human, wherein the base station is used for vehicle tracking, drone tracking, and human tracking.
